(19) United States
(12) Patent Application Publication
(10) Pub. No.: US 2012/0251237 A1
(43) Pub. Date: Oct. 4, 2012

(54) Load-Limiting Devices

(75) Inventors: Philip John Dandy, Farnborough (GB); David Peter Banks-Fear, Christchurch (GB)

(73) Assignee: QINETIQ LIMITED, London (GB)

(21) Appl. No.: 13/076,827

(22) Filed: Mar. 31, 2011

(51) Int. Cl. E01F 13/12; F16B 1/00

(52) U.S. Cl. 404/6; 403/41

(57) ABSTRACT

A load-limiting device is formed from a length of wire with a coil at each end defining eyes by which the device can be connected into a system adapted to be loaded in tension. The coils are of different diameter and the larger diameter coil is adapted to unwind by plastic deformation of the wire when the device is subject to a tensile load of a predetermined magnitude. The use of such devices in a system for deploying a vehicle arresting device across a roadway is also described.

### FIELD OF THE INVENTION

The invention relates to load-limiting devices and more particularly to a device adapted to limit the tensile load within a system in which it is incorporated.

### BACKGROUND OF THE INVENTION

The invention has been developed specifically for limiting tensile loads within a system such as described in U.S. patent application Ser. No. 12/992507 for deploying a vehicle arresting device of the kind described in U.S. Pat. No. 7862251, the contents of which are incorporated herein by reference. The vehicle arrester comprises a flexible substrate in the form of a net and with an array of spikes along its leading edge, which is deployed by pulling it across a road, from a folded condition on one side of the road, to lie flat on the ground in the path of a target vehicle. This is accomplished by cables attached to one side edge of the net which are wound in by a winch located on the opposite side of the road, while the other side edge of the net is anchored to the ground through lanyards on the first side of the road. In use, when a vehicle runs over the deployed net, some of the spikes at its leading edge become lodged in the front tires of the vehicle, the net therefore wraps around the front wheels and the portion of the net between those wheels pulls tight under the vehicle until its tension prevents further rotation of the wheels, thereby bringing the vehicle safely to a stop.

The cables in the above deployment system are attached to the net through respective weak links in the form of plastics electrical cable ties which are intended to break under a predetermined tension to release the cables from the net when the latter has been unfolded and pulled across the road as far as permitted by its anchorage to the ground on the first side of the road. The lanyards on the first side of the road are also attached to the net through respective weak links intended to break under a predetermined tension so that the net can detach from its anchorage during the course of a vehicle arrest. In practice this has been provided by selected weak link stitching at the net end of each lanyard and the tension at which these are intended to fail is higher than that for the plastics ties on the opposite side of the net so that the latter fail in preference during the course of deployment of the net.

In practice it has been found that the kinds of weak links described above are not entirely reliable in that there can be wide variations in the tensile load at which each type actually fails. In the case of the plastics ties this can be affected by variations in temperature and the extent of ultra violet degradation of the plastics material. In the case of weak stitching it is difficult to achieve sufficiently tight manufacturing tolerances and the strength of such stitching can also decrease with age. It has also been found that breakage of the plastics ties during deployment of the net can sometimes cause the net to recoil so that it does not thereafter lie evenly on the ground.

It is therefore one object of the present invention to provide a load-limiting device of a simple and low-cost design which can be employed more reliably in the kind of service described above. Furthermore it would be desirable to reduce the peak loads in the system when the net suddenly tightens during deployment and when the net pulls against its anchorage during a vehicle arrest by providing a form of device which can absorb energy at these events prior to release. Still further it would be desirable to provide a form of device between the net and the deployment cables which is capable of significant elongation when the net tightens during deployment but without releasing until a vehicle arrest, to avoid the recoil effect mentioned above and to compensate for misalignment in the system set-up geometry, and therefore help to achieve an even net lay.

### SUMMARY OF THE INVENTION

With the foregoing in mind in one aspect the present invention resides in a load-limiting device including a coil of material comprising at least one complete turn defining an eye for connection of the device to another element and which is adapted to unwind by plastic deformation of said material when the device is subject to a tensile load of a predetermined magnitude applied through said eye.

In practice the load which will be sufficient to initiate and maintain unwinding of the coil in such a device will depend on the strength and thickness of the material in question and the diameter of the coil, while the length to which it unwinds (and consequently the time taken for complete unwinding and the total energy it can absorb) will depend on the number of turns in the coil.

In a preferred embodiment the device is formed from a single length of wire and has a second coil defining a second eye for connection of the device to another element at the opposite end of the device to the first coil. The second coil is of a smaller diameter than the first coil so that it will not unwind when subject to the tension which is capable of unwinding the first coil.

When used in a vehicle arrestor deployment system of the kind described above there may be one such load-limiting device connected between each winch cable (or other such flexible tension member) and one side of the arrestor and one such load-limiting device connected between each anchorage lanyard (or other such flexible tension member) and the other side of the arrestor, the devices on the lanyard side having a higher threshold tensile load to cause unwinding than the devices on the cable side so that the latter will elongate in preference during deployment.

Devices according to the invention may however also have utility in various other applications where it is desired to limit the tensile load in a system and absorb energy by elongation prior to release from the system. Examples may include the release of tethered animals when a sufficient pull is applied e.g. in the event of fire, or the protection from overload of rigging or sail attachments on sailing boats. Such devices could also be modified to permit elongation and energy absorption when subject to a threshold loading but not ultimate release at all if a terminal portion of the coil is welded or otherwise made fast with an adjacent turn to prevent it unwinding completely. This may be useful e.g. for a fall arrest system for persons working at height where unwinding of the coil could break and slow a fall if connected between a safety rope and a harness but not allow detachment from the rope at the end of its elongation.

The extent of elongation of devices according to the invention could also be used for indication of the extent of travel or deflection of structures during transient events. For example they could record how far a bridge moves due to high wind or impact, or record how far an item within packaging or a container has moved during transit.

### BRIEF DESCRIPTION OF THE DRAWINGS

These and other objects and features of the present invention will now be more particularly described, by way of example, with reference to the accompanying drawings, in which:

FIG. 1 is a schematic plan view of one embodiment of a deployment system for a vehicle arresting device in which load-limiting devices in accordance with the invention can be used;

FIG. 2 is a schematic end view of the vehicle arresting device from FIG. 1 in its initial folded condition on the ground, to an enlarged scale;

FIGS. 3 and 4 are respectively top and side views of a first form of load-limiting device according to the invention for use in the system of FIG. 1, in its undeformed condition;

FIG. 5 illustrates a typical load/elongation characteristic for a load-limiting device according to the invention;

FIGS. 6 and 7 are respectively top and side views of the device of FIGS. 3 and 4 in a partially elongated condition;

FIGS. 8 and 9 are respectively top and side views of a second form of load-limiting device according to the invention for use in the system of FIG. 1, in its undeformed condition; and

FIGS. 10 and 11 are respectively top and side views of a further form of load-limiting device according to the invention.

### DETAILED DESCRIPTION OF THE PREFERRED EMBODIMENTS

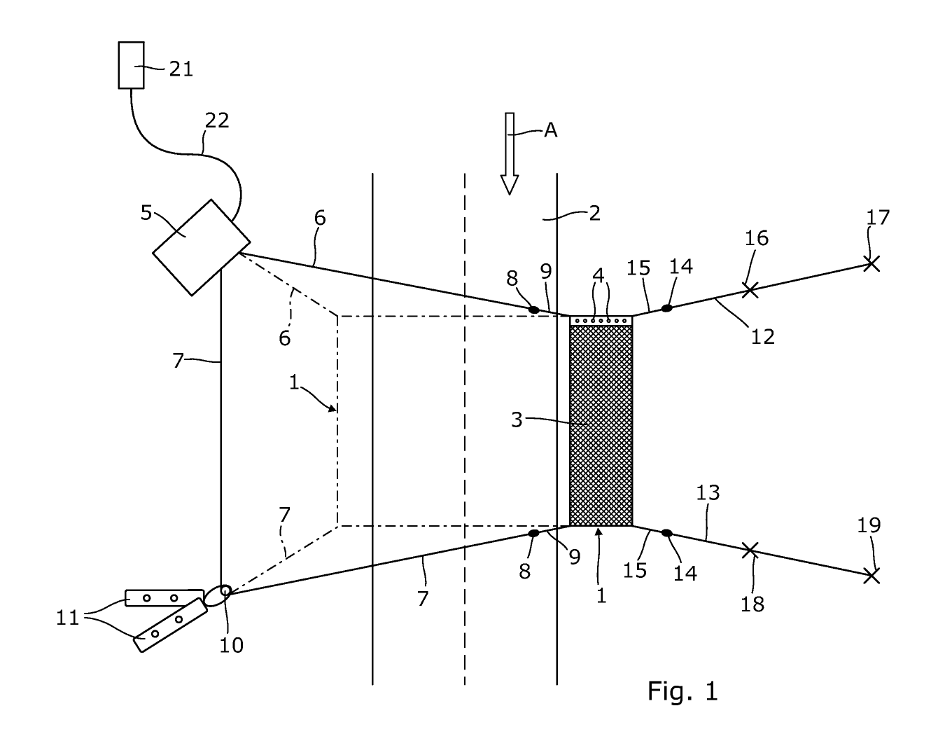

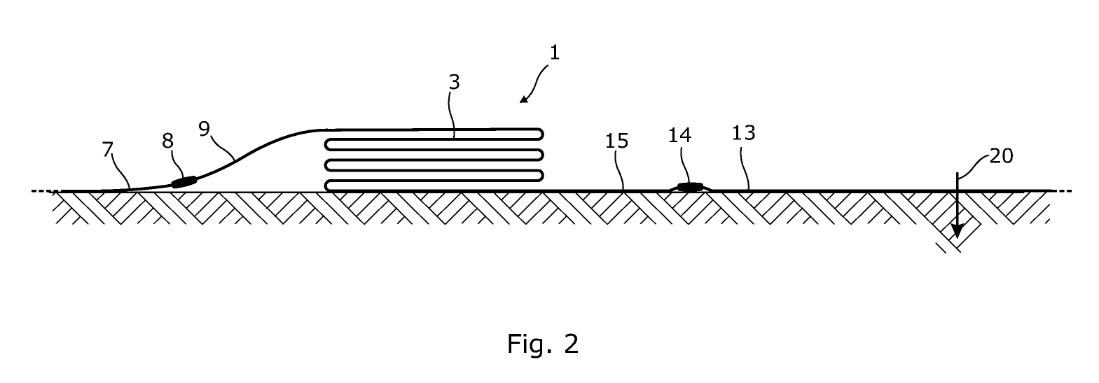

With reference to FIG. 1 there is shown a vehicle arresting device 1 of the kind more fully described and illustrated in U.S. Pat. No. 7,862,251 in a folded condition to one side of a roadway 2 and ready to be deployed in the path of a target vehicle (not shown) approaching in the direction of the arrow A. The device 1 comprises a net 3 of rectangular planform intended to lie flat across the roadway when deployed and equipped with one or more rows of barbed spikes 4 along its leading edge (in the sense of the direction of approach A). It is folded laterally upon itself in concertina fashion as indicated in FIG. 2 (from which the spikes 4 are omitted for ease of illustration and in which the successive leaves of the folded net are shown spaced from each other in the vertical direction also for ease of illustration). In use, when a vehicle encounters the deployed device 1 (the device being then in the position notionally illustrated in broken line in FIG. 1) from the direction of arrow A, its front tires will run over a number of adjacent spikes 4 (being then extending upwardly from the leading edge of the net 3) which become lodged in those tires. The net 3 therefore becomes attached to the front wheels of the vehicle at two locations across its width and continued movement of the vehicle causes the net to wrap around those wheels, the portion of the net between the wheels being pulled tight under the vehicle and around suspension components until its tension prevents further rotation of the wheels, thereby bringing the vehicle to a stop all as described in U.S. Pat. No. 7,862,251.

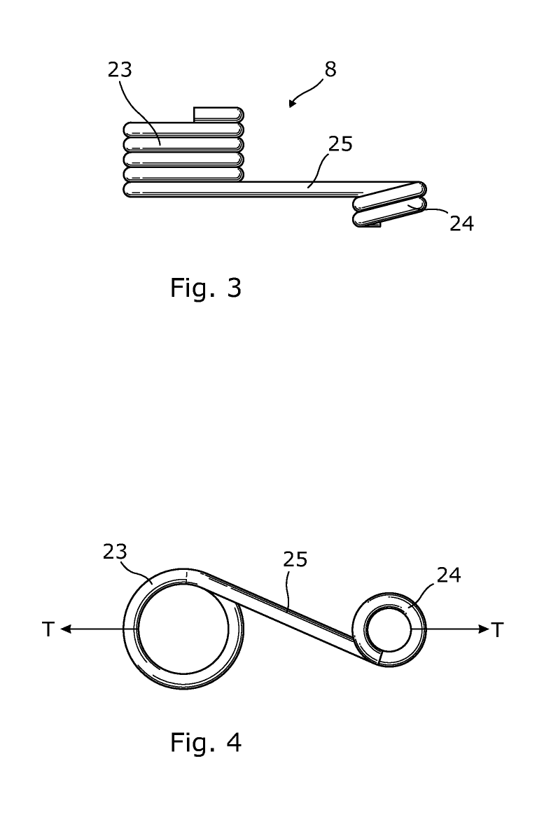

Returning to the pre-deployment condition of the device 1 in FIG. 1, a winch 5 is firmly anchored to the ground on the opposite side of the roadway 2 to the folded device 1 and slightly “upstream” from the device 1 in the sense of the arrow A. A pair of cables 6 and 7 extend from the winch 5 across the roadway 2 and are attached, through respective load-limiting devices 8 to be more particularly described with reference to FIGS. 3 and 4, to cords 9 which extend from the respective corner regions of the closer side edge of the net 3, that is to say the edge at the upper left hand side of the folded device as viewed in FIG. 2. The cable 6 to the leading edge of the device 1 runs directly across the roadway 2 from the winch 5 in the illustrated embodiment. The cable 7 to the trailing edge of the device 1, however, firstly runs from the winch 5 approximately parallel to the roadway to a turn pulley 10 on the same side as the winch, and thence across the roadway to the device 1. The turn pulley 10 is itself firmly anchored to the ground through a pair of straps 11 and located slightly “downstream” from the device 1 in the sense of the arrow A. It follows from this layout of the device 1, winch 5 and turn pulley 10 that the cables 6 and 7 diverge at oblique angles with respect to the device 1 towards the winch 5.

The winch 5 is powered by means of a spring mechanism. It has a pair of drums, one for each cable 6,7, which can be set to turn independently to allow the cables to be run out and connected to the device 1 and their slack then taken up, and can then be locked together to wind in the cables simultaneously when the device is to be deployed.

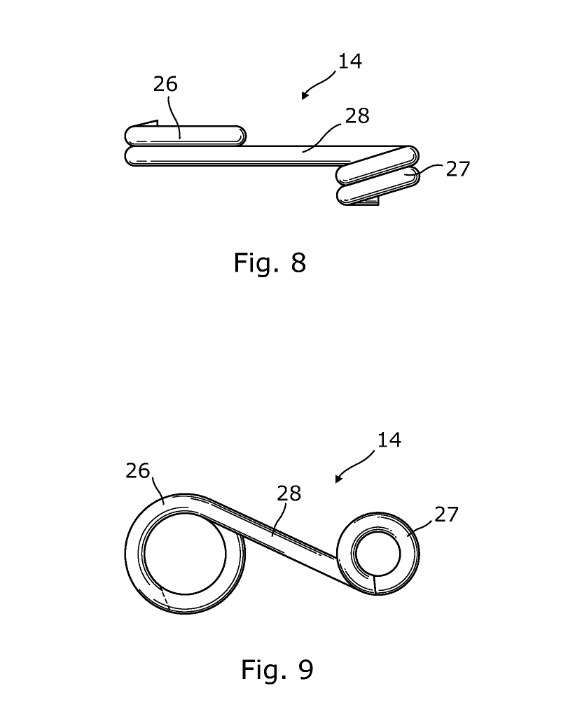

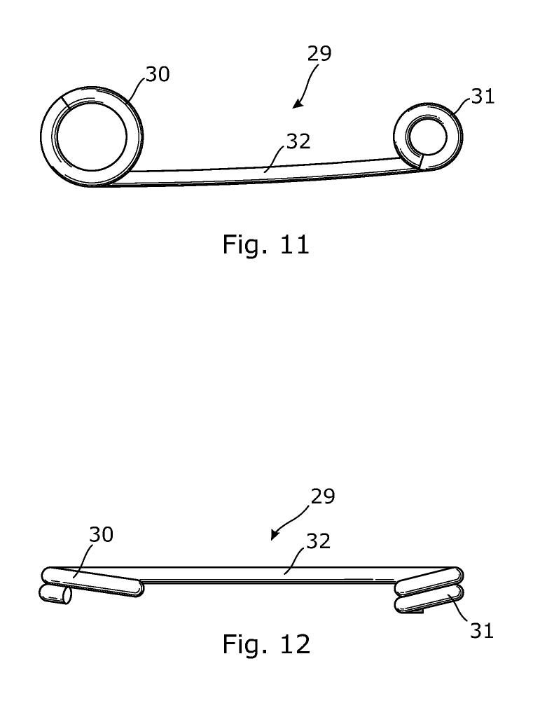

To avoid a situation in which, when the winch 5 is operated, the vehicle arresting device 1 is not only unfolded but dragged as a whole across the roadway 2 away from the side on which it is initially laid, it is necessary to anchor it to the ground on that side of the roadway through its side edge that is remote from the cables 6 and 7—that is to say the edge that is at the lower right hand side of the net 3 in the folded condition as viewed in FIG. 2. For this purpose a pair of lanyards 12 and 13 are attached, through respective load-limiting devices 14 to be more particularly described with reference to FIGS. 8 and 9, to cords 15 which extend from respective corner regions of that side edge of the net and these lanyards are firmly anchored to the ground at the positions indicated at 16-19. As shown in FIG. 1, these lanyards are positioned to diverge at oblique angles with respect to the device and in the opposite direction to the cables 6 and 7. They may themselves be in the form of cables or ropes but preferably are in the form of lengths of webbing equipped with eyelets for ground anchors at the positions 16-19. These ground anchors (one of which is notionally indicated at 20 for the lanyard 13 in FIG. 2) will be selected according to the prevailing ground conditions where the device 1 is to be deployed but may be in the form of stakes similar to large tent pegs where the ground is relatively soft or heavy-duty masonry nails where the device is to be deployed in an urban environment over concrete or asphalt for example. Eyelets of different sizes suited to the different types of ground anchors available may be provided in the lanyards 12,13 at each position 16-19. Similar types of anchors may be selected for the anchorage of the winch 5 and pulley straps 11.

Unfolding and deployment of the device 1 from the position shown in full line in FIG. 1 to the position shown in broken line in that Figure is accomplished by running the winch 5 to simultaneously wind in the cables 6 and 7. This may be initiated by any suitable means but in FIG. 1 is notionally indicated as a footswitch 21 connected to the winch 5 through an electrical cable 22 and which can be actuated by a human operator situated at a safe distance from the arrester when a target vehicle is sighted. The signal from the switch 21 may actuate a solenoid in the winch 5 to withdraw a lock on the drums and release the spring mechanism.

In any event operation of the winch 5 winds in the cables 6 and 7 initially to the positions shown for them in broken line in FIG. 1. During this movement it will be appreciated that the side edges of the net 3 will be kept under tension as well as its leading and trailing edges by virtue of the divergent disposition of the cables 6,7 and lanyards 12,13 and this will help to ensure that the device is left in an even and wrinkle-free condition across the roadway with the spikes 4 in their intended upright orientation. In particular the tension in the near side edge (to the cables 6 and 7) prevents it from dragging or catching on the ground and causing wrinkles throughout the net. In addition a degree of fore and aft “float” is afforded to the device 1 by virtue of the disposition of the lanyards 12,13 and their points of anchorage to the ground which means that the device is to some extent self-correcting for variations in the alignment of the system during deployment as more fully described in U.S. patent application Ser. No. 12/992507 (WO2009/147363).

Description will now be directed to the load-limiting device 8 illustrated in FIGS. 3 and 4, one of which is connected between each cable 6,7 and the vehicle arresting device 1. It comprises a single length of stainless steel wire formed into close wound coils 23 and 24 of larger and smaller diameter respectively at opposite ends of a central straight portion 25. More particularly, as viewed in FIG. 4 and commencing from the leftmost free end, the wire winds clockwise for five complete turns to define the coil 23, remains straight for the central portion 25, and then winds anti-clockwise for two complete turns to define the coil 24.

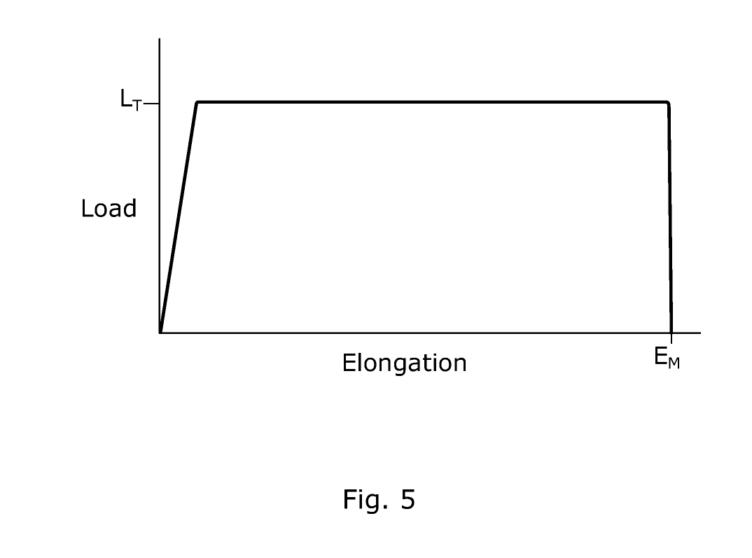

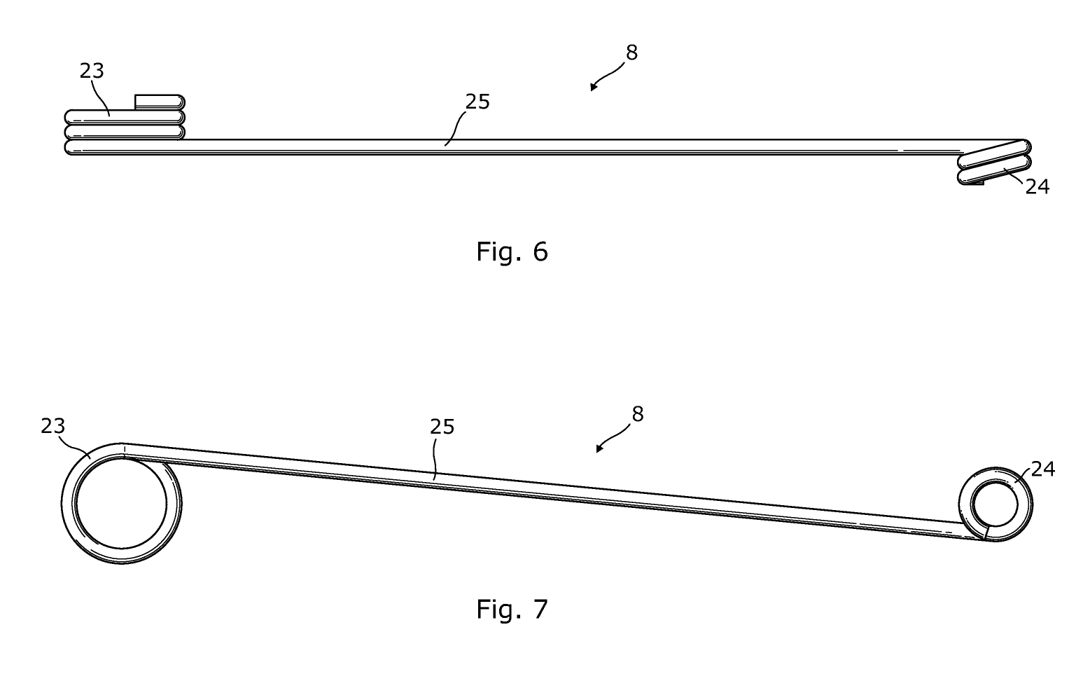

In use of the device 8 it can act to limit the tensile load within a system, in which it may be incorporated e.g. by means of shackles, dog clips, carabiners, delta links or the like connectors passing through the eyes defined by coils 23 and 24, so that it is placed under tension in the sense of the arrows T in FIG. 4. When loaded like this it will behave in the manner indicated by the typical load/elongation characteristic shown in FIG. 5. That is to say it will initially behave elastically but when a predetermined threshold load L_{T} is reached the coil 23 will begin to unwind by plastic deformation of the wire at the junction between that coil and the portion 25. So long as that load level is maintained the coil 23 will continue to unwind from its junction with the central portion, with the position of that junction progressing along the wire and the central portion therefore effectively lengthening as the coil straightens, and this behaviour will limit the tensile load within the system to the value of L_{T}. By way of example FIGS. 6 and 7 illustrate the situation when the coil 23 has unwound by two complete turns; (note that FIG. 7 shows a somewhat idealised situation in relation to the elongation of the device and in practice the central portion of the device may exhibit an element of residual curvature as it lengthens). In the limit, if the load is maintained or reapplied for the period which it takes for the coil to unwind completely it will release from the relevant connector and the tension will be relieved completely. This condition corresponds to the maximum elongation of the device 8, or the value E_{M} in FIG. 5.

In a load-limiting device of the form illustrated, it is always the larger diameter coil such as 23 that will unwind when the device is placed under sufficient tension, in preference to the smaller diameter coil such as 24, because of the larger moment generated in the larger coil. Devices of this form can easily be “tuned” to provide a desired combination of load limitation (L_{T}) and maximum pull-out distance (E_{M}) by appropriate selection of the wire and coil diameters and the number of turns in the larger coil. By way of example each of the devices 14 incorporated between the net 3 and the lanyards 12,13 and illustrated in FIGS. 8 and 9 is of the same general form as the device 8, comprising larger and smaller diameter coils 26 and 27 and a central straight portion 28. The diameters of the coils 26 and 27 are substantially the same as those of the coils 23 and 24 respectively but the device 14 is formed from a thicker gauge of wire than the device 8 and its coil 26 has only 1.5 turns. It follows therefore that as compared to the device 8 the device 14 will have a higher L_{T} but a lower E_{M}.

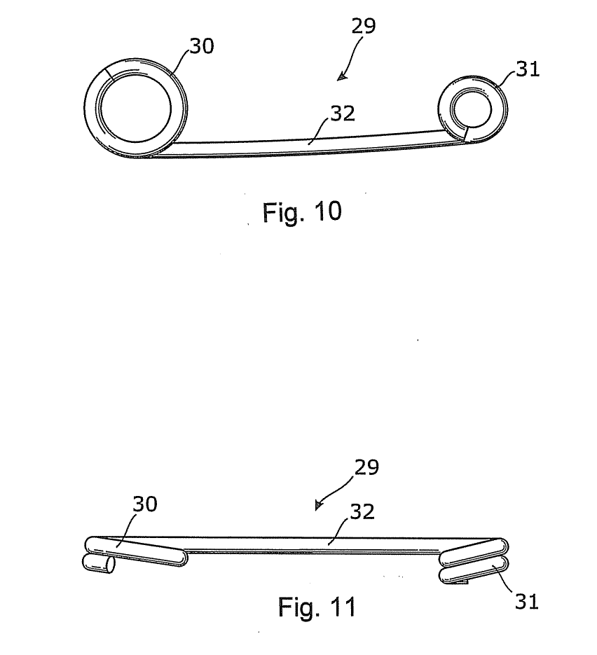

Although the illustrated devices 8 and 14 are wound with both of their coils on opposite sides of the respective central portion 25 or 28 in the sense as viewed in FIGS. 3 and 8, equivalent devices can be produced with the coils on the same side. Also, by reversing the hand of one of the coils they will both lie to the same side of the central portion as viewed in elevation. An example exhibiting both of these variations is shown in FIGS. 10 and 11 where another load-limiting device 29 according to the invention comprises larger and smaller coils 30 and 31 joined by a central portion 32.

Returning to FIG. 1, when the device 1 has unfolded completely and reached across the roadway 2 as far as it can go (broken line position) it will pull tight against the restraint of the lanyards 12,13 and the tension in the cables 6 and 7 will suddenly rise. This will be limited, however, to the L_{T} of the devices 8, the coils 23 of which will commence unwinding at this point. They will continue to unwind, limiting the load in the system and absorbing the inertial energy of the winch 5, until the tension in the cables falls below the L_{T} of the devices 8. At this point unwinding of the coils will cease and a residual tension will remain in the cables 6 and 7 due to the spring loading of the winch 5, helping to keep the device 1 flat and wrinkle-free. It is noted in this respect that there are sufficient turns in the coils 23 to enable the devices 8 to elongate sufficiently to absorb and limit the peak loads of net tightening during deployment but not to release the cables 6,7 from the cords 9 during deployment. Also the static load that the winch 5 can apply is below the L_{T} of the devices 8. Due to variations in the geometry of the system as set up on any occasion one of the cables 6 or 7 may tighten before the other, meaning that one of the devices 8 may elongate earlier and through a greater distance than the other. This mechanism therefore acts to compensate for misalignment in the system and further helps to achieve an even net lay.

At no time during the deployment of the device 1 will the load-limiting devices 14 on the lanyard side of the device 1 begin to elongate, as their L₁ is substantially higher than that of the devices 8. More particularly the L_{T} of the devices 8 is above the resistance to deployment due to the weight of the device 1 but substantially below the peak loads on tightening during deployment which would exist in the absence of those devices, while the L_{T} of the devices 14 is above that of the devices 8 but below the force to dislodge any of the ground anchors for any of the system components.

During a vehicle arrest, all of the devices 8 and 14 will elongate to the point of release to disconnect the cables 6,7 from the cords 9 and to disconnect the lanyards 12,13 from the cords 15, as the net 3 wraps around the vehicle's wheels and is carried along by the vehicle. It is desirable that the device 1 detaches in this way from the cables and lanyards in the course of an arrest (i) to prevent damage to the winch 5, (ii) to prevent flying object hazards and (iii) to limit the restraining forces which can be applied by the deployment and anchoring system components to the net in opposition to the engagement of the spikes 4 in the vehicle tires and thereby avoid the risk of the spikes being pulled from the tires by those components as the net is carried along by the vehicle.

As indicated in the Summary, for other applications devices according to the invention can also be provided where the applicable coil unwinds to absorb energy when subject to a threshold loading but cannot ultimately release, and for this purpose devices similar to those of FIGS. 3 and 4, 8 and 9 or 10 and 11 could be modified by welding the terminal part (free end) of the coil 23, 26 or 30 to the adjacent turn.

1. A load-limiting device according to claim 16 wherein deformation of said first coil is initially elastic, but for a substantial portion of the unwinding is a plastic deformation having a constant load vs. elongation characteristic.

2. A device according to claim 16 wherein said first coil comprises several turns.

3. A device according to claim 16 wherein the number of turns in said first coil is in the range of 1.5 to 5.

4. (canceled)

5. (canceled)

6. A device according to claim 16 wherein a terminal portion of the first coil is fastened with an adjacent turn thereof to prevent the first coil unwinding completely.

7. A system adapted to be loaded in tension in use thereof and incorporating a device according to claim 16.

8. (canceled)

9. A system comprising:
a vehicle arresting device comprising a flexible substrate of generally rectangular planform intended to lie flat upon the ground when deployed, with an array of upwardly-directed spikes attached to the substrate along a leading portion thereof; and
a system for deploying said device across a vehicle pathway from a folded condition to one side of said pathway where it is anchored, comprising respective first flexible tension members connected to respective corner regions of the device at one side edge thereof and a winch for winding in said first flexible tension members from a position to the side of said pathway opposite to said one side thereof;
first load-limiting devices connected between said first flexible tension members and the vehicle arresting device; wherein the vehicle arresting device is anchored at said one side of said pathway through respective second flexible tension members connected to respective corner regions of the device at the side edge thereof opposite to said one side edge; and
second load-limiting devices connected between said second flexible tension members and the vehicle arresting device, the magnitude of the tensile load under which the first coils of the second load-limiting devices are adapted to unwind being greater than that under which the first coils of the first load-limiting devices are adapted to unwind wherein the first load limiting devices and the second load limiting devices are load limiting devices according to claim 16.

10. (canceled)

11. The system according to claim 9 wherein said substrate is in the form of a net.

12. A vehicle arresting device, flexible tension members, a winch, load-limiting devices, and anchorage means for the vehicle arresting device, all adapted for use in a system according to claim 9.

13. A method of deploying the vehicle arresting device in a system according to claim 9 in which the winch is operated to wind the first flexible tension members so that the vehicle arresting device is unfolded and drawn across the vehicle pathway, and when each first flexible tension member tightens against the anchorage of the vehicle arresting device the first coil of the respective first load-limiting device is caused to unwind, the strength of the winch and the number of turns in each said first coil being such that the extent of said unwinding is less than that to cause disconnection of the respective first flexible tension member from the vehicle arresting device.

14. A method of arresting a vehicle with the deployed vehicle arresting device in a system according to claim 9 in which when the front tires of the vehicle run over the leading portion of that device one or more said spikes become lodged in each said tire, the substrate becomes wrapped around the front wheels of the vehicle, and the first coils of all of said load-limiting devices are caused to unwind to the extent that all of said flexible tension members become disconnected from the vehicle arresting device.

15. The system according to claim 9 wherein the completely unwound length of the first coils of the first load-limiting devices is greater than that of the first coils of said second load-limiting devices.

16. A load-limiting device formed from a length of wire comprising:
a first coil at a first end of the length of wire comprising at least one complete turn defining a first eye for connection of the device to another element; and
a second coil at the second end of the length of wire comprising at least one complete turn defining a second eye for connection of the device to another element;
said first coil being adapted to unwind by plastic deformation of the wire when the device is subject to a tensile load of a predetermined magnitude applied through said eyes; and
said second coil being of a smaller diameter than said first coil whereby it is adapted not to unwind when the device is subject to a tensile load of said predetermined magnitude applied through said eyes.
